(19) United States
(12) Patent Application Publication
(10) Pub. No.: US 2016/0266059 A1
(43) Pub. Date: Sep. 15, 2016

(54) TESTING DEVICE AND METHOD FOR THE NONDESTRUCTIVE TESTING OF A COMPONENT

(71) Applicant: SIEMENS AKTIENGESELLSCHAFT, MUNCHEN (DE)

(72) Inventor: STEFAN OBERMAYR, DUISBURG (DE)

(21) Appl. No.: 15/055,819

(22) Filed: Feb. 29, 2016

(30) Foreign Application Priority Data
Mar. 10, 2015 (DE) 102015204264.2

(51) Int. Cl. G01N 27/02; G01N 29/24; G01N 29/04; G01B 5/004

(52) U.S. Cl. CPC G01N 27/025; G01B 5/004; G01N 29/2443; G01N 29/04; G01N 2291/0237; G01N 2291/0289

(57) ABSTRACT

A testing device for the nondestructive testing of a component, including a test head for generating a scanning signal and for detecting a measuring signal, information concerning the quality of the by means of the measuring signal, wherein also provided is an OLED film, which during the testing is to be arranged on a surface of the component that is to be tested, and in that:
a. the OLED film comprises a detection layer for recording position coordinates, or
b. the OLED film is designed to represent the measuring signals detected by the test head on the OLED film, or
c. the OLED film comprises a detection layer for recording position coordinates and is designed to represent on the OLED film the measuring signals detected by the test head in dependence on the position coordinates detected by means of the OLED film.

### CROSS-REFERENCE TO RELATED APPLICATIONS

This application claims priority to German Patent_Application No. 102015204264.2 having a filing date of Mar. 10, 2015, the entire contents of which are hereby incorporated by reference.

### FIELD OF TECHNOLOGY

The following relates to a testing device for the nondestructive testing of a component, comprising a test head for generating a scanning signal and for detecting a measuring signal, information concerning the quality of the component, in particular concerning defects such as cracks or the like, being determinable by means of the measuring signal.

Embodiments of the invention also relates to a method for the nondestructive testing of a component by means of a testing device, comprising the steps that:
a test head is positioned in relation to a component to be tested,
scanning signals are generated in the component by means of the test head,
during the generation of scanning signals, measuring signals are recorded, providing information on the quality of the component, in particular on the position and/or size of defects, such as cracks or the like, in dependence on the scanning signals generated,
the recorded measuring signals are evaluated and visually represented on an output device in order to obtain the information on the quality of the component.

### BACKGROUND

Various methods are known for examining components in a nondestructive manner for the presence of defects, such as cracks, voids or the like, and for estimating or determining the size of defects that are present. For example, ultrasonic testing is used for volume testing and eddy current testing is used for surface testing.

In the case of eddy current testing, an eddy current probe is used as the test head, and this is moved along the surface of a component to be tested. By means of a coil provided in the eddy current probe and serving as an exciter coil, an alternating magnetic field is generated and induces eddy currents in the part of the component that is to be tested. The eddy currents for their part generate a secondary alternating magnetic field, which induces in a detection coil a voltage of which the amplitude and phase are in relation to the electrical properties of the component to be tested. Defects in the material of the component have a characteristic influence on the induced secondary alternating magnetic field, and consequently on the voltage induced in the detection coil. The detection coil may in principle be a component that is separate from the exciter coil, or the exciter coil itself assumes the function of the detection coil.

In the case of ultrasonic testing, an ultrasound probe is used as the test head. It comprises for example a piezoelectric material, for example a quartz crystal. By applying an electrical voltage to the quartz crystal, the latter is deformed. If the ultrasound probe is moved over the surface of a component to be tested, ultrasonic waves propagating from the surface of the component are generated as a result of the electrical and mechanical forces acting. The ultrasonic waves generated are diffracted at defects in the component. The diffracted ultrasonic signal is recorded by a suitable detector and evaluated, in order to determine the position and size of defects in the component. The suitable detector may be provided by the quartz crystal itself, so that it serves simultaneously as the exciter and the detector for the ultrasonic waves.

In the case of both methods, the measuring signals recorded are evaluated and visually represented by means of an output device. In addition to the guiding of the test head over the component, it is necessary in the case of both methods simultaneously to observe the detected measuring signal on the output device. The exact guidance of the test head, in particular maintaining the track offset, is made more difficult as a result. For example, the requirement may be to move the test head over the component in a meandering manner with a fixed track offset.

The devices and methods known for the nondestructive testing of components have proven successful. However, it is regarded as disadvantageous that this device and the method require exact guidance of the test head while looking away from the test head toward the output device. This requires a high degree of experience. In particular in the case of components of a large surface area, it is found to be particularly difficult for the test to cover all segments of the component to be tested.

Furthermore, the use of a displacement sensor is possible in order to indicate on the output device the regions in which measuring signals have already been recorded. The use of displacement sensors leads to increased mechanical complexity, and associated more difficult handling, for which reason they tend not to be used in the case of manual testing.

### SUMMARY

On the basis of the known art, an aspect relates to providing a device and a method of the type mentioned at the beginning which in the testing of a component facilitate the guidance of the test head and the simultaneous observation of the measuring signals represented on an output device.

This type mentioned at the beginning by also providing an OLED film, which during the testing is to be arranged on a surface of the component that is to be tested, and by:
a) the OLED film comprising a detection layer for recording position coordinates and being designed to represent the measuring signals detected by the test head in dependence on the position coordinates detected by means of the OLED film, or
b) the OLED film being designed to represent the measuring signals detected by the test head on the OLED film, or
c) the OLED film comprising a detection layer for recording position coordinates and being designed to represent on the OLED film the measuring signals detected by the test head in dependence on the position coordinates detected by means of the OLED film.

The aspect is also achieved in the case of a method of the type mentioned at the beginning by the testing device being used and by guiding the test head over the OLED film during the testing, wherein:
a) the position coordinates of the test head are recorded by means of the OLED film and the measuring signals detected by the test head are displayed in dependence on the position coordinates detected by means of the OLED film, or
b) the measuring signals detected by the test head are displayed on the OLED film, or
c) the position coordinates of the test head are recorded by means of the OLED film and the measuring signals detected by the test head are displayed on the OLED film in dependence on the position coordinates detected by means of the OLED film.

Embodiments of the present invention are consequently based on the idea of arranging an OLED film on the component during the testing and guiding the test head over the OLED film. When doing so, measuring signals detected by the test head can be represented directly on the OLED film, whereby it is no longer necessary to look away from the test head to observe the measuring signals. As a result, manual testing is made much easier and intuitive handling of the testing device is made possible.

Furthermore, position coordinates can be detected by means of an OLED film that comprises a detection layer, and the measuring signals detected by the test head can be displayed on the output device in dependence on the position coordinates detected by means of the OLED film. As a result, handling is improved in comparison with the displacement sensors that are used in the prior art. In comparison with mechanized testing, this manual method for the nondestructive testing of a component requires a much lower level of mechanical complexity, while the information determined with respect to the quality of the component is comparable.

Furthermore, both the position coordinates of the test head are recorded by means of the OLED film and the measuring signals detected by the test head are displayed on the OLED film in dependence on the position coordinates detected by means of the OLED film. As a result, both handling and simultaneous observation of the measuring signals and guidance of the test head are made easier.

According to a preferred development, it is provided that the test head comprises an ultrasound probe and/or an eddy current probe. As a result, it is advantageously made possible to record defects on the surface of a component and/or in regions of the component further to the inside.

In a development of embodiments of the invention it is provided that regions of the component that have defects and regions of the component that are free from defects have a different visual identification on the OLED film, in particular are represented in different colors. This advantageously makes it possible to show in a representation not only the position coordinates but also the amount of the amplitude of the measuring signal by means of a color coding or grayscale coding. In this case, the measuring signals recorded are represented on the OLED film location-dependently. Information concerning the quality of the component, such as for example the depth of cracks, is to be represented by means of the color coding or grayscale coding.

Embodiments of the invention also provide that the measuring signals detected by the test head are displayed on the OLED film at the places at which they are detected. This allows the measuring signals to be represented on the OLED film in the ratio of 1:1, so that the size and position of the measuring signals represented on the OLED film coincide exactly with the defects or the like that are present in the component.

According to a preferred development, it is provided that the position coordinates have an X coordinate and a Y coordinate, the X coordinate extending in a longitudinal direction of the OLED film and the Y coordinate extending perpendicularly thereto. As a result, the position of the X axis and the Y axis is adapted to the extents of the OLED film.

In a way known per se, a control unit may be provided, connected here to the test head and the OLED film, the detected measuring signals being evaluated by means of the control unit in order to obtain information on the quality of the component. This advantageously makes it possible to transmit the measuring signals detected by the test head and the position coordinates detected by means of the OLED film to the control unit and evaluate them there. After the evaluation, the data may be transmitted to the OLED film, in order to visually represent it there.

### BRIEF DESCRIPTION

Some of the embodiments will be described in detail, with reference to the following FIGURE, wherein like designations denote like members, wherein:

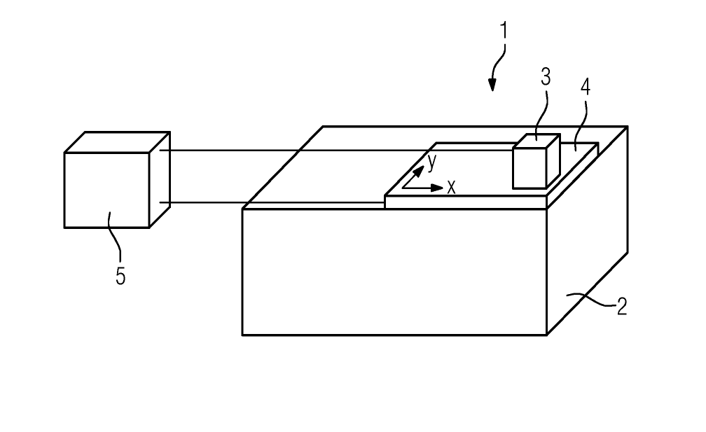

FIG. 1 shows a schematic representation of a component to be tested and a testing device.

### DETAILED DESCRIPTION

FIG. 1 shows in a schematic representation a testing device 1 according to embodiments of the present invention and a cuboidal component 2 to be tested. The testing device 1 comprises a test head 3 and an OLED film 4. The test head 3 may have an ultrasound probe and/or an eddy current probe, the ultrasound probe comprising for example a piezoelectric material for generating ultrasonic waves. Whereas the eddy current probe has a coil for generating an alternating magnetic field. Measuring signals by way of which information concerning the quality of the component 2, in particular defects, such as cracks or the like, is determined are detected by means of the test head 3.

The OLED film 4 comprises a detection layer for recording position coordinates, for example taking the form of a pressure-sensitive film. An X coordinate and a Y coordinate of the position coordinates are recorded by means of the detection layer. The X coordinate is in this case determined along a longitudinal direction of the OLED film 4 and the Y coordinate is determined perpendicularly thereto.

The testing device 1 also comprises a control unit 5, which is connected to the test head 3 and the OLED film 4. The control unit 5 serves for the evaluation of the measuring signal detected by the test head 3 and the position coordinates detected by the OLED film 4.

For the nondestructive testing of the component 2, the OLED film 4 is arranged on the component 2 to be tested, and the test head 3 is guided manually over the OLED film 4. With particular preference, the test head 3 is guided over the OLED film 4 in a meandering manner with a fixed track offset.

A scanning signal is generated by means of the test head 3. When an ultrasound probe is used as the test head 3, ultrasonic waves propagating from the surface of the component are generated by the quartz crystal. The quartz crystal is thereby deformed by applying an electrical voltage. The ultrasonic waves generated are deflected at defects in the component 2 and detected by means of the quartz crystal.

In the case of eddy current testing, an alternating magnetic field is generated by means of the coil. As a result, eddy currents are induced in the part of the component 2 that is to be tested and for their part generate a secondary alternating magnetic field. This has the effect of inducing in the coil a voltage of which the amplitude and phase are in relation to the electrical properties of the component 2 to be tested. Defects in the material of the component 2 have a characteristic influence on the induced secondary alternating magnetic field, and consequently on the voltage induced in the coil.

The position coordinates of the test head 3 are recorded by means of the OLED film 4 and the measuring signals detected by the test head 3 are displayed on the OLED film 4 in dependence on the position coordinates detected by means of the OLED film 4.

Regions of the component 2 that have defects and regions of the component 2 that are free from defects have a different visual identification on the OLED film 4, in particular they are represented in different colors. The use of a color coding or grayscale coding allows not only the X and Y coordinates of the position coordinates but also the information extracted from the measuring signal concerning the quality of the component, for example the depth of cracks, to be represented in a color-coded or grayscale-coded manner. For this purpose, the measuring signals recorded are represented on the OLED film 4 location-dependently.

The measuring signals detected by the test head 3 are displayed on the OLED film 4 at the respective places at which they are detected. This results in a representation of the measuring signals on the OLED film in the ratio of 1:1. In other words, the position and size of defects are displayed exactly on the OLED film 4. The regions that have defects and the regions that are free from defects are represented here in different colors.

When an ultrasound probe is used, for the acoustic coupling a coupling agent, for example coupling gel, water or oil, is applied between the OLED film 4 and the component 2.

When an eddy current probe is used, the scanning signal is amplified in dependence on the thickness of the OLED film 4.

Although the invention has been illustrated more specifically and described in detail by the preferred exemplary embodiment, the invention is not restricted by the disclosed examples and other variations may be derived therefrom by a person skilled in the art without departing from the scope of protection of the invention.

1. A testing device for the nondestructive testing of a component, comprising a test head for generating a scanning signal and for detecting a measuring signal, information concerning the quality of the component, in particular concerning defects such as cracks or the like, being determinable by means of the measuring signal, wherein also provided is an OLED film, which during the testing is to be arranged on a surface of the component that is to be tested, and in that:
a. the OLED film comprises a detection layer for recording position coordinates and is designed to represent the measuring signals detected by the test head in dependence on the position coordinates detected by means of the OLED film, or
b. the OLED film is designed to represent the measuring signals detected by the test head on the OLED film, or
c. the OLED film comprises a detection layer for recording position coordinates and is designed to represent on the OLED film the measuring signals detected by the test head in dependence on the position coordinates detected by means of the OLED film.

2. The testing device as claimed in claim 1, wherein the test head comprises an ultrasound probe and/or an eddy current probe.

3. The testing device as claimed in claim 1, wherein regions of the component that have defects and regions of the component that are free from defects have a different visual identification on the OLED film.

4. The testing device as claimed in claim 1, wherein a control unit is also provided, connected to the test head and the OLED film, the detected measuring signals being evaluated by means of the control unit in order to obtain information on the quality of the component.

5. The testing device as claimed in one of the preceding claims, wherein the position coordinates have an X coordinate and a Y coordinate, the X coordinate extending in a longitudinal direction of the OLED film and the Y coordinate extending perpendicularly thereto.

6. A method for the nondestructive testing of a component by means of a testing device, comprising the steps:
providing a test head positioned in relation to a component) to be tested,
generating scanning signals in the component by means of the test head,
recording, during the generation of scanning signals, measuring signals, providing information on the quality of the component, on the position and/or size of defects, in dependence on the scanning signals generated,
the recorded measuring signals are evaluated and visually represented on an output device in order to obtain the information on the quality of the component, wherein a testing device as claimed in claim 1 is used and the test head is guided over the OLED film during the testing, and wherein:
a) recording the position coordinates of the test head by means of the OLED film and the measuring signals detected by the test head are displayed in dependence on the position coordinates detected by means of the OLED film, or
b) displaying the measuring signals detected by the test head on the OLED film, or
c) recording the position coordinates of the test head by means of the OLED film and the measuring signals detected by the test head are displayed on the OLED film in dependence on the position coordinates detected by means of the OLED film.

7. The method as claimed in claim 6, wherein regions of the component that have defects and regions of the component that are free from defects are identical visually differently on the OLED film, in particular are represented in different colors.

8. The method as claimed in claim 6, wherein an X coordinate and a Y coordinate of the position coordinates are detected, the X coordinate extending in a longitudinal direction of the OLED film and the Y coordinate extending perpendicularly thereto.

9. The method as claimed in claim 6, wherein the measuring signals detected by the test head are displayed on the OLED film at the places at which they are detected.

10. A use of an OLED film in the nondestructive testing of a component.

11. The use of an OLED film as claimed in claim 10, wherein the OLED film comprises a detection layer for recording position coordinates.
